(19) United States
(12) Patent Application Publication
(10) Pub. No.: US 2007/0106774 A1
(43) Pub. Date: May 10, 2007

(54) Computer system controlling bandwidth according to priority state

(76) Inventors: Daisuke Yokota, Kawasaki (JP); Shinji Kimura, Sagamihara (JP); Shuichi Nemoto, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/345,317

(22) Filed: Feb. 2, 2006

(30) Foreign Application Priority Data
Nov. 7, 2005 (JP) 2005-322177

(51) Int. Cl. G06F 15/173

(52) U.S. Cl. 709/223

(57) ABSTRACT

Provided is a bandwidth control method for a computer system that includes: at least one storage system; a plurality of host computers connected to the storage system via a network; and a management computer connected to the host computers, the method including the steps of: monitoring a state of the host computers; judging whether or not the each host computer is in a priority state in which operation of the host computer needs to be given priority over other host computers; communicating over a priority bandwidth when it is judged that the host computer is in a priority state; and communicating, when it is judged that the host computer is not in a priority state, over a non-priority bandwidth, which corresponds to one of a part and an entirety of a bandwidth remaining after allocating priority bandwidths to other host computers that are in a priority state.

### CLAIM OF PRIORITY

The present application claims priority from Japanese patent application P2005-322177 filed on Nov. 7, 2005, the content of which is hereby incorporated by reference into this application.

### BACKGROUND

This invention relates to a computer system including a storage system, a computer, and a management computer, and more specifically to a bandwidth control technique for a network that connects a computer to a storage system.

In a computer system where a plurality of computers share the same network, excessive load applied by some of the computers can congest the network and thus delay processing of the rest of the computers.

A technique for solving this problem is disclosed in JP 2005-51811 A. With this technique, the amount of bandwidth allocated to a computer is determined by the type of application the computer executes.

### SUMMARY

According to JP 2005-51811 A, the conventional technique does not take into account the manipulation state of a computer in determining the amount of bandwidth to be allocated to the computer. Computers in general do not stop operating the moment users cease to manipulate the computers, but keep operating while there are no inputs from users.

For instance, a computer that executes a file search application creates a file index while it is not being manipulated by a user. When not manipulated by a user, the computer does not require a quick response. A problem of the conventional technique is that, despite this fact, the computer heavily loads down a network and thereby delays processing of the network's other computers that are being manipulated by users.

This invention has been made in view of the problem described above, and it is therefore an object of this invention to provide a computer system that allocates to each computer a bandwidth suited to the state of the computer.

According to a representative aspect of this invention, there is provided a computer system, including: at least one storage system; a plurality of host computers connected to the storage system via a network; and a management computer connected to the host computers, the storage system including: a first interface connected to the network; a first processor connected to the first interface; a first memory connected to the first processor; and a disk drive for storing data requested by the host computers to be written, the host computers each including: a second interface connected to the network; a second processor connected to the second interface; and a second memory connected to the second processor, the management computer including: a third interface connected to the host computers; a third processor connected to the third interface; and a third memory connected to the third processor, in which the second processor monitors a state of the host computer to which the second processor belongs, in which the second processor judges whether or not the state is a priority state in which operation of the host computer monitored by the second processor needs to be given priority, in which, when the state is judged as a priority state, the second processor performs communication over a priority bandwidth, and in which, when the state is judged as not a priority state, the second processor performs communication over a non-priority bandwidth, which corresponds to one of a part and an entirety of a bandwidth remaining after allocating priority bandwidths to other host computers that are in a priority state.

According to a representative embodiment of this invention, each computer is allocated a bandwidth suited to the state of the computer.

### BRIEF DESCRIPTION OF THE DRAWINGS

The present invention can be appreciated by the description which follows in conjunction with the following figures, wherein:

FIG. 1 is a block diagram of a computer system according to a first embodiment;

FIG. 2 is a block diagram of a computer according to the first embodiment;

FIG. 3 is a block diagram about functions of the computer system according to the first embodiment;

FIG. 4 is a configuration diagram of bandwidth information management tables according to the first embodiment;

FIG. 5 is an explanatory diagram of a bandwidth information management table update packet according to the first embodiment;

FIG. 6 is an explanatory diagram of an iSCSI packet according to the first embodiment which follows the iSCSI protocol;

FIG. 7 is an explanatory diagram of an iSCSI header in the iSCSI packet according to the first embodiment;

FIG. 8 is a flow chart for processing of an active state/user state management unit in a bandwidth management server according to the first embodiment;

FIG. 9 is a flow chart for processing of a transmission/reception rate control unit in the computer according to the first embodiment;

FIG. 10 is a block diagram of a computer system according to the second embodiment; and

FIG. 11 is a block diagram about functions of a computer according to the second embodiment.

### DETAILED DESCRIPTION OF THE PREFERRED EMBODIMENT

Embodiments of this invention will be described below with reference to the accompanying drawings.

(First Embodiment)

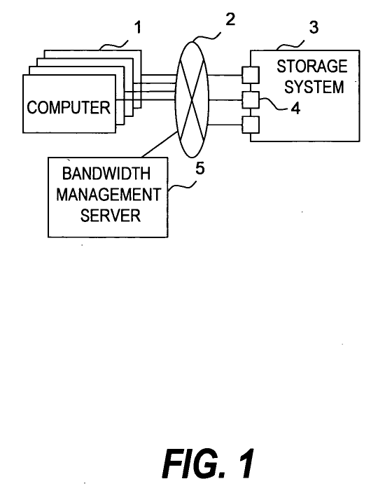

FIG. 1 is a block diagram of a computer system according to a first embodiment.

The computer system includes computers 1, a network 2, a storage system 3, and a bandwidth management server 5.

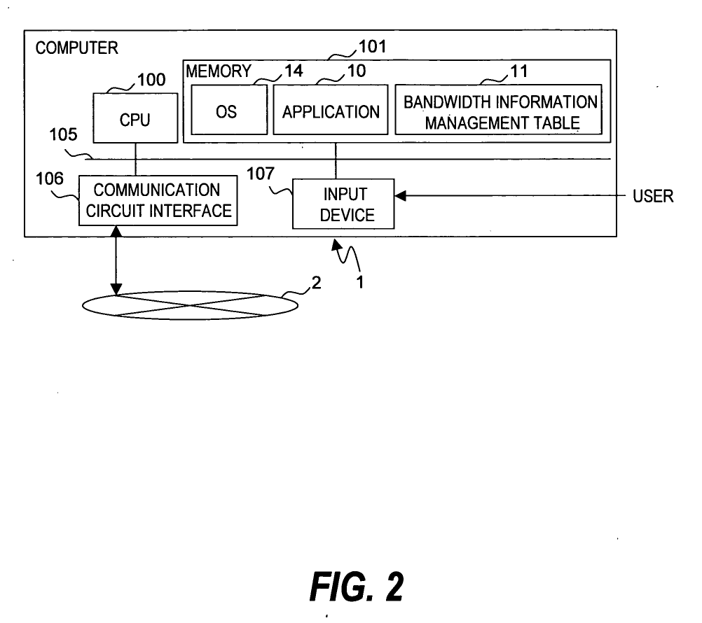

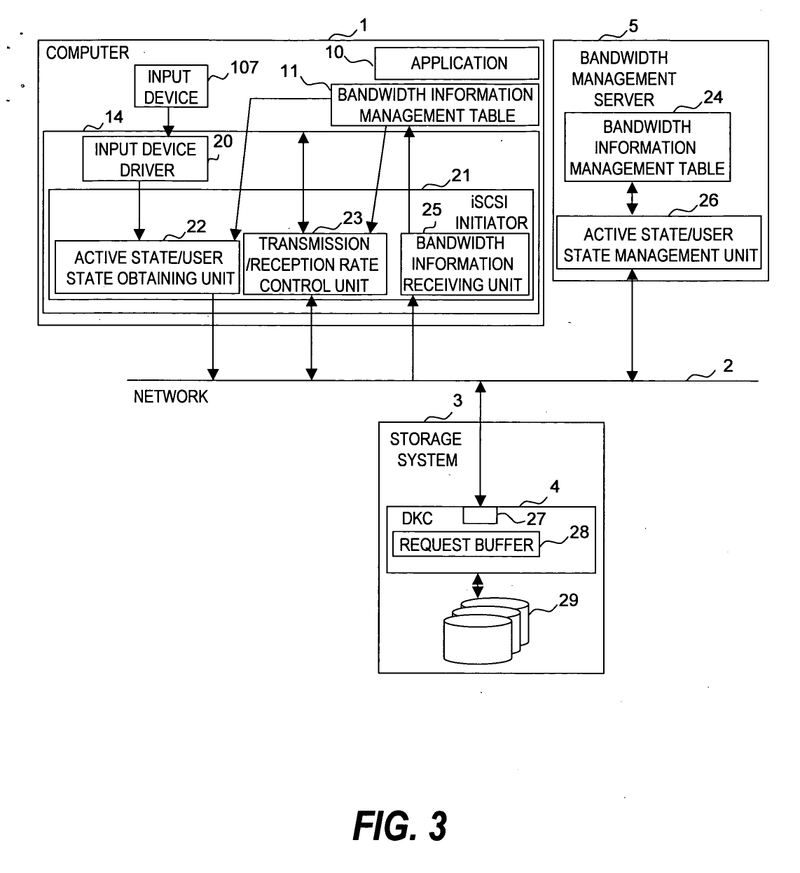

The computers 1 read and write data in the storage system 3 as will be described in detail with reference to FIG. 2. The storage system 3 stores data requested by the computers 1 to be written as will be described in detail with reference to FIG. 3. The storage system 3 has a plurality of input/output ports 4, which connect the storage system 3 to the network 2.

The network 2 connects the computers 1, the storage system 3, and the bandwidth management server 5 to one another. The network 2 is, for example, a LAN (Local Area Network) composed of a router, a network switch, and others.

The bandwidth management server 5 controls the bandwidth of the network 2 as will be described in detail with reference to FIG. 2.

FIG. 2 is a block diagram of the computers 1 according to the first embodiment.

The computers 1 each have a CPU (Central Processing Unit) 100, a memory 101, an internal bus 105, a communication circuit interface 106, and an input device 107. The CPU 100, the memory 101, the communication circuit interface 106, and the input device 107 are interconnected by the internal bus 105.

The CPU 100 executes various types of processing by executing programs that are stored in the memory 101.

The memory 101 is constituted of a RAM (Random Access Memory) or the like. The memory 101 stores programs executed by the CPU 100 and other data. Specifically, an application 10, an OS (Operating System) 14, and a bandwidth information management table 11 are stored in the memory 101.

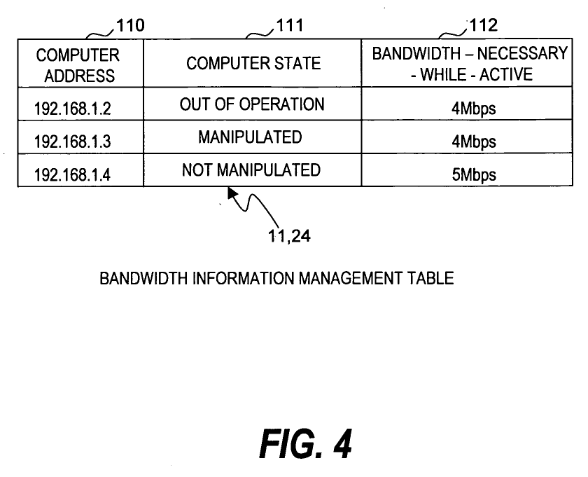

The application 10 and the OS 14 will be described in detail with reference to FIG. 3. The bandwidth information management table 11 will be described in detail with reference to FIG. 4.

The communication circuit interface 106 is connected to the network 2. A user inputs information to the input device 107. The input device 107 sends the inputted information to the CPU 100. The input device is, for example, a keyboard or a mouse.

FIG. 3 is a block diagram about functions of the computer system according to the first embodiment.

The computer 1 stores the application 10, the OS 14, and the bandwidth information management table 11 in the memory 101.

The application 10 executes various types of processing. For instance, the application 10 instructs the OS 14 to write data in disks 29 of the storage system 3. The application 10 also instructs the OS 14 to read data out of the disks 29 of the storage system 3.

The OS 14 controls the entire computer 1. For instance, upon reception of an instruction from the application 10, the OS 14 issues a disk access request. A disk access request can be a data write request, a data read request, or the like. The OS 14 includes an input device driver 20 and an iSCSI initiator 21.

The input device driver 20 processes information inputted through the input device 107. Specifically, the input device driver 20 sends, to an active state/user state obtaining unit 22, information inputted through the input device 107.

The iSCSI initiator 21 uses the iSCSI protocol to communicate with the storage system 3 and the bandwidth management server 5. For instance, the iSCSI initiator 21 sends a disk access request issued by the OS 14 to the storage system 3 via the network 2. The iSCSI initiator 21 also receives a disk access result from the storage system 3, and sends the received result to the application 10. A disk access result includes data read out of the disks 29 and others.

The iSCSI initiator 21 includes the active state/user state obtaining unit 22, a transmission/reception rate control unit 23, the bandwidth information management table 11, and a bandwidth information receiving unit 25.

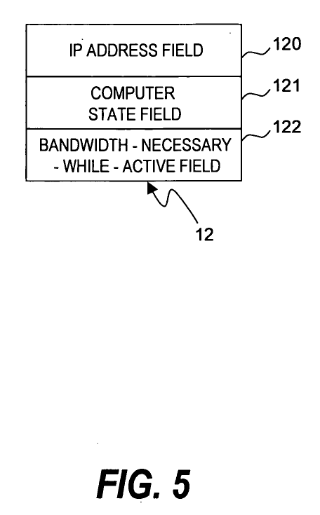

The active state/user state obtaining unit 22 monitors the active state of the computer 1 and the user manipulation state of the computer 1 based on information sent from the input device driver 20. Detecting a change in state it monitors, the active state/user state obtaining unit 22 sends, to the bandwidth management server 5, a bandwidth information management table update packet shown in FIG. 5.

The active state/user state obtaining unit 22 may use other information than one sent from the input device driver 20 in monitoring the user manipulation state of the computer 1.

For instance, the active state/user state obtaining unit 22 judges that the computer 1 is being manipulated when a user is near the computer 1. When there is no user near the computer 1, the active state/user state obtaining unit 22 judges that the computer 1 is not being manipulated. The active state/user state obtaining unit 22 uses, for example, an image of the surroundings of the computer 1 that is picked up by a camera to judge whether a user is near the computer 1 or not. Information obtained from a sensor net system, a security card reader, or the like may also be used by the active state/user state obtaining unit 22 in judging whether a user is near the computer 1 or not.

The transmission/reception rate control unit 23 uses the iSCSI protocol to communicate with the storage system 3. The transmission/reception rate control unit 23 controls the bandwidth of the network 2 by controlling transmission and reception of iSCSI packets.

The bandwidth information management table 11 manages, as will be described later with reference to FIG. 4, the state of the computer 1 provided in the computer system. The bandwidth information management table 11 is the same as a bandwidth information management table 24 of the bandwidth management server 5.

The bandwidth information receiving unit 25 receives a bandwidth information management table update packet shown in FIG. 5 from the bandwidth management server 5. Based on the received bandwidth information management table update packet, the bandwidth information receiving unit 25 updates the bandwidth information management table 11. The bandwidth information receiving unit 25 thus synchronizes the bandwidth information management table 11 of the computer 1 with the bandwidth information management table 24 of the bandwidth management server 5.

In the case where this embodiment is applied to a disk-less system, the CPU 100 of the computer 1 reads programs and data out of the disks 29 of the storage system 3, and stores the read programs and data in the memory 101. The CPU 100 also stores, in the disks 29 of the storage system 3, calculation results stored in the memory 101.

The storage system 3 has a disk controller 27 and the disks 29.

The disk controller 27 reads and writes data in the disks 29. The disk controller 27 includes the input/output ports 4 and a request buffer 28.

The input/output ports 4 are connected to the network 2. The request buffer 28 temporarily stores a disk access request sent from the computer 1.

The disks 29 store data requested by the computer 1 to be written and other data.

The disk controller 27 receives a disk access request from the computer 1 and stores the received disk access request in the request buffer 28. Then the disk controller 27 reads or writes data in the disks 29 according to the disk access request stored in the request buffer 28. The disk controller 27 next sends the result of the read or write (disk access result) to the computer 1. Thereafter, the disk controller 27 deletes the disk access request from the request buffer 28.

The bandwidth management server 5 has a CPU, a memory, and an interface. The CPU performs various types of processing by executing programs stored in the memory. The interface is connected to the network 2.

The memory stores programs executed by the CPU and other data. Specifically, the bandwidth information management table 24 and an active state/user state management unit 26 are stored in the memory.

The bandwidth information management table 24 manages, as will be described later with reference to FIG. 4, the state of the computer 1 provided in the computer system. The bandwidth information management table 24 is the same as the bandwidth information management table 11 of the computer 1.

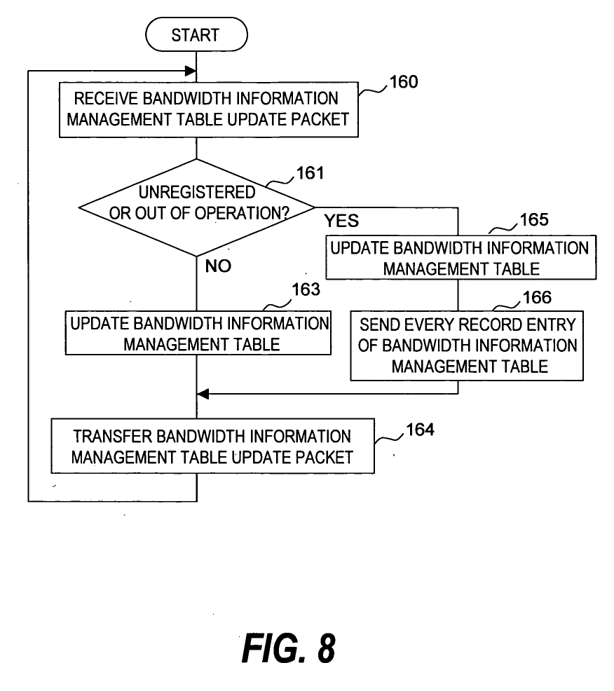

The active state/user state management unit 26 updates the bandwidth information management table 24 as will be described later with reference to FIG. 8.

FIG. 4 is a configuration diagram of the bandwidth information management tables 11 and 24 according to the first embodiment.

The bandwidth information management tables 11 and 24 each include a computer address 110, a computer state 111, and a bandwidth-necessary-while-active 112.

The computer address 110 indicates an IP address assigned to each computer 1.

The computer state 111 indicates whether the computer 1 identified by the computer address 110 is out of operation, manipulated, or not manipulated. Specifically, when the computer 1 is not activated, “out of operation” is written as the computer state 111. When the computer 1 is active and has been manipulated by a user within a given time period, “manipulated” is written as the computer state 111. When the computer 1 is active but has not been manipulated by a user within a given time period, “not manipulated” is written as the computer state 111.

The bandwidth-necessary-while-activated 112 indicates a bandwidth the computer 1 needs while being active.

FIG. 5 is an explanatory diagram of a bandwidth information management table update packet 12 according to the first embodiment.

The bandwidth information management table update packet 12 includes an IP address field 120, a computer state field 121, and a bandwidth-necessary-while-active field 122.

The IP address field 120 stores the IP address of a computer that has experienced a change in state. The computer state field 121 stores the state of this computer after the change. Specifically, whether the computer is out of operation, manipulated, or not manipulated is stored in the computer state field 121.

The bandwidth-necessary-while-active field 122 stores a bandwidth the computer 1 needs while being active.

The bandwidth information management table update packet 12 is sent from the active state/user state obtaining unit 22 of the computer 1 to the active state/user state management unit 26 of the bandwidth management server 5. The bandwidth information management table update packet 12 is also sent from the active state/user state management unit 26 of the bandwidth management server 5 to the bandwidth information receiving unit 25 of the computer 1.

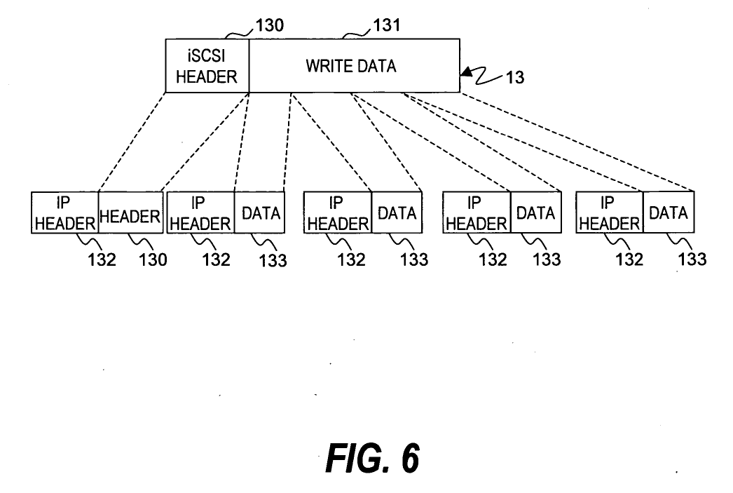

FIG. 6 is an explanatory diagram of an iSCSI packet. 13 according to the first embodiment which follows the iSCSI protocol.

The iSCSI packet 13 in the explanatory diagram of FIG. 6 is a write request sent from the computer 1 to the storage system 3.

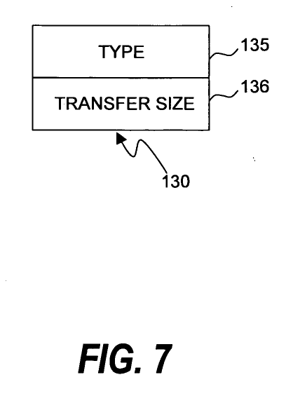

The iSCSI packet 13 includes an iSCSI header 130 and write data 131. The iSCSI header 130 includes, as will be described later with reference to FIG. 7, information about the iSCSI packet 13. The write data 131 is data requested to be written in the disks 29 of the storage system 3.

When sending the iSCSI packet 13 to the storage system 3, the computer 1 divides the write data 131 in the iSCSI packet 13 to be sent into pieces each of which is smaller than a maximum IP packet size. In the explanatory diagram of FIG. 6, the computer 1 divides the write data 131 in the iSCSI packet 13 into four data pieces 133.

Then the computer 1 adds an IP header 132 to each of the data pieces 133 and to the iSCSI header 130 of the iSCSI packet 13 in question, thereby creating IP packets. The computer 1 sends the created IP packets to the storage system 3 via the network 2.

Described next is a case in which the iSCSI packet 13 is a packet for sending a result of a read request. The iSCSI packet 13 in this case includes read data instead of the write data 131. The term read data refers to data read out of the disks 29 of the storage system 3.

When sending the iSCSI packet 13 to the computer 1, the storage system 3 divides read data in the iSCSI packet 13 to be sent into data pieces 133 each of which is smaller than a maximum IP packet size.

Then the storage system 3 adds an IP header 132 to each of the data pieces 133 and to the iSCSI header 130 of the iSCSI packet 13 in question, thereby creating IP packets. The storage system 3 sends the created IP packets to the computer 1 via the network 2.

Described next is a case in which the iSCSI packet 13 is a read request. In this case, the computer 1 creates an IP packet by adding an IP header 132 to the iSCSI packet 13 without dividing the iSCSI packet 13. The computer 1 sends the created IP packet to the storage system 3 via the network 2.

FIG. 7 is an explanatory diagram of the iSCSI header 130 in the iSCSI packet 13 according to the first embodiment.

The iSCSI header 130 includes a type 135 and a transfer size 136.

The type 135 indicates the type of the iSCSI packet 13 in question. For instance, the type 135 indicates whether the iSCSI packet 13 is a write request or a read request.

The transfer size 136 indicates the size of data to be transferred by this packet. When the iSCSI packet 13 is a write request, for example, the size of the write data 131 included in the iSCSI packet 13 refers to the transfer size 136. When the iSCSI packet 13 is a read request, the size of read data included in the iSCSI packet 13 refers to the transfer size 136.

FIG. 8 is a flow chart for processing of the active state/user state management unit 26 in the bandwidth management server 5 according to the first embodiment.

The active state/user state obtaining unit 22 of the computer 1 monitors the active state of the computer 1 and the user manipulation state of the computer 1. Detecting a change in either state, the active state/user state obtaining unit 22 sends the bandwidth information management table update packet 12 shown in FIG. 5 to the active state/user state management unit 26 of the bandwidth management server 5.

For instance, as the power of the computer 1 is turned on, the OS 14 of this computer 1 is activated. The OS 14 activates the iSCSI initiator 21. The active state/user state obtaining unit 22 of the iSCSI initiator 21 creates the bandwidth information management table update packet 12.

Specifically, the active state/user state obtaining unit 22 stores the IP address of the computer 1 to which it belongs in the IP address field 120 of the bandwidth information management table update packet 12. Then the active state/user state obtaining unit 22 stores “not manipulated” in the computer state field 121 of the bandwidth information management table update packet 12. The active state/user state obtaining unit 22 next stores a bandwidth that is set in advance in the bandwidth-necessary-while-active field 122 of the bandwidth information management table update packet 12.

Thereafter, the active state/user state obtaining unit 22 sends the created bandwidth information management table update packet 12 to the active state/user state management unit 26 of the bandwidth management server 5.

The active state/user state obtaining unit 22 uses information sent from the input device driver 20 to monitor the user manipulation state of the computer 1. Detecting a change in manipulation state, the active state/user state obtaining unit 22 sends the bandwidth information management table update packet 12 shown in FIG. 5 to the bandwidth management server 5.

To give an example, a case in which the computer 1 is in a “manipulated” state will be described. In this case, the active state/user state obtaining unit 22 waits to create the bandwidth information management table update packet 12 until a given time period elapses without a user manipulating the input device 107.

Specifically, the active state/user state obtaining unit 22 stores the IP address of the computer 1 to which it belongs in the IP address field 120 of the bandwidth information management table update packet 12. Then the active state/user state obtaining unit 22 stores “not manipulated” in the computer state field 121 of the bandwidth information management table update packet 12. The active state/user state obtaining unit 22 next stores a bandwidth that is set in advance in the bandwidth-necessary-while-active field 122 of the bandwidth information management table update packet 12.

Thereafter, the active state/user state obtaining unit 22 sends the created bandwidth information management table update packet 12 to the active state/user state management unit 26 of the bandwidth management server 5.

A case in which the computer 1 is in a “not manipulated” state will be described. In this case, the active state/user state obtaining unit 22 waits to create the bandwidth information management table update packet 12 until the input device 107 is manipulated.

Specifically, the active state/user state obtaining unit 22 stores the IP address of the computer 1 to which it belongs in the IP address field 120 of the bandwidth information management table update packet 12. Then the active state/user state obtaining unit 22 stores “manipulated” in the computer state field 121 of the bandwidth information management table update packet 12. The active state/user state obtaining unit 22 next stores a bandwidth that is set in advance in the bandwidth-necessary-while-active field 122 of the bandwidth information management table update packet 12.

Thereafter, the active state/user state obtaining unit 22 sends the created bandwidth information management table update packet 12 to the active state/user state management unit 26 of the bandwidth management server 5.

The active state/user state management unit 26 of the bandwidth management server 5 receives the bandwidth information management table update packet 12 from the active state/user state obtaining unit 22 of the computer 1 (160).

The active state/user state management unit 26 extracts an IP address stored in the IP address field 120 of the received bandwidth information management table update packet 12. Then the active state/user state management unit 26 judges whether or not the bandwidth information management table 24 has a record entry whose computer address 110 matches the extracted IP address.

When there is no record entry that has the extracted IP address, the active state/user state management unit 26 judges that information of the computer 1 to which the extracted IP address is assigned is not registered in the bandwidth information management table 24, and proceeds to step 165.

When there is a record entry that has the extracted IP address, the active state/user state management unit 26 picks up from the bandwidth information management table 24 the record entry whose computer address 110 matches the extracted IP address. Then the active state/user state management unit 26 extracts the computer state 111 from the picked up record entry. The active state/user state management unit 26 judges whether or not the extracted computer state 111 says “out of operation” (161).

When “out of operation” is written as the computer state 111, the active state/user state management unit 26 proceeds to step 165.

When other states than “out of operation” are written as the computer state 111, the active state/user state management unit 26 judges that the computer 1 that has sent the bandwidth information management table update packet 12 is storing the bandwidth information management table 11. Accordingly, the active state/user state management unit 26 does not need to send every entry of the bandwidth information management table 11.

Based on the received bandwidth information management table update packet 12, active state/user state management unit 26 updates the bandwidth information management table 24 (163).

Specifically, the active state/user state management unit 26 extracts an IP address stored in the IP address field 120 of the received bandwidth information management table update packet 12. The active state/user state management unit 26 then picks up from the bandwidth information management table 24 a record entry whose computer address 110 matches the extracted IP address. Then the active state/user state management unit 26 stores, as the computer state 111 of the picked up record entry, a value stored in the computer state field 121 of the received bandwidth information management table update packet 12. The active state/user state management unit 26 stores, as the bandwidth-necessary-while-active 112 of the picked up record entry, a value stored in the bandwidth-necessary-while-active field 122 of the received bandwidth information management table update packet 12.

Thereafter, the active state/user state management unit 26 extracts the computer address 110 from every record entry of the bandwidth information management table 24, and transfers the bandwidth information management table update packet 12 received in step 160 to the extracted computer address 110 (164). The active state/user state management unit 26 then returns to step 160.

The bandwidth information receiving unit 25 of the computer 1 receives the bandwidth information management table update packet 12. Based on the received bandwidth information management table update packet 12, the bandwidth information receiving unit 25 updates the bandwidth information management table 11.

Specifically, the bandwidth information receiving unit 25 extracts an IP address stored in the IP address field 120 of the received bandwidth information management table update packet 12. The bandwidth information receiving unit 25 then picks up from the bandwidth information management table 11 a record entry whose computer address 110 matches the extracted IP address. Then the bandwidth information receiving unit 25 stores, as the computer state 111 of the picked up record entry, a value stored in the computer state field 121 of the received bandwidth information management table update packet 12. The bandwidth information receiving unit 25 stores, as the bandwidth-necessary-while-active 112 of the picked up record entry, a value stored in the bandwidth-necessary-while-active field 122 of the received bandwidth information management table update packet 12.

In step 165, the active state/user state management unit 26 of the bandwidth management server 5 updates the bandwidth information management table 24 based on the received bandwidth information management table update packet 12.

Described first is a case in which the active state/user state management unit 26 judges in step 161 that the IP address extracted from the bandwidth information management table update packet 12 has not been registered in the bandwidth information management table 24.

In this case, the active state/user state management unit 26 adds a new record entry to the bandwidth information management table 24. As the computer address 110 of the new record entry, the active state/user state management unit 26 stores the IP address extracted from the bandwidth information management table update packet 12. The active state/user state management unit 26 then stores, as the computer state 111 of the new record entry, a value stored in the computer state field 121 of the received bandwidth information management table update packet 12. A value stored in the bandwidth-necessary-while-active field 122 of the received bandwidth information management table update packet 12 is entered as the bandwidth-necessary-while-active 112 of the new record entry.

Described next is a case in which the active state/user state management unit 26 judges in step 161 that the computer 1 to which the IP address extracted from the bandwidth information management table update packet 12 is assigned is “out of operation”.

In this case, the active state/user state management unit 26 picks up from the bandwidth information management table 24 a record entry whose computer address 110 matches the IP address extracted from the bandwidth information management table update packet 12. The active state/user state management unit 26 stores, as the computer state 111 of the picked up record entry, a value stored in the computer state field 121 of the received bandwidth information management table update packet 12. Then the active state/user state management unit 26 enters, as the bandwidth-necessary-while-active 112 of the picked up record entry, a value stored in the bandwidth-necessary-while-active field 122 of the received bandwidth information management table update packet 12.

Next, the active state/user state management unit 26 sends information about every record entry of the bandwidth information management table 24 to the IP address extracted from the bandwidth information management table update packet 12 (166).

The active state/user state management unit 26 here picks up all record entries of the bandwidth information management table 24 one by one. Based on the picked up record entry, the active state/user state management unit 26 creates the bandwidth information management table update packet 12. Specifically, the active state/user state management unit 26 stores the computer address 110 of the picked up record entry in the IP address field 120 of the bandwidth information management table update packet 12. The computer state 111 of the picked up record entry is stored in the computer state field 121 of the bandwidth information management table update packet 12. The bandwidth-necessary-while-active 112 of the picked up record entry is stored in the bandwidth-necessary-while-active field 122 of the bandwidth information management table update packet 12.

The active state/user state management unit 26 sends the created bandwidth information management table update packet 12 to the bandwidth information receiving unit 25 of the computer 1. The active state/user state management unit 26 then proceeds to step 164.

The bandwidth information receiving unit 25 of the computer 1 receives the bandwidth information management table update packet 12. Based on the received bandwidth information management table update packet 12, the bandwidth information receiving unit 25 updates the bandwidth information management table 11.

Specifically, the bandwidth information receiving unit 25 extracts an IP address stored in the IP address field 120 of the received bandwidth information management table update packet 12. The bandwidth information receiving unit 25 then judges whether or not the bandwidth information management table 11 has a record entry whose computer address 110 matches the extracted IP address.

When there is a record entry that has the extracted IP address, the bandwidth information receiving unit 25 picks up from the bandwidth information management table 11 the record entry whose computer address 110 matches the extracted IP address. The bandwidth information receiving unit 25 stores, as the computer state 111 of the picked up record entry, a value stored in the computer state field 121 of the received bandwidth information management table update packet 12. Then the bandwidth information receiving unit 25 enters, as the bandwidth-necessary-while-active 112 of the picked up record entry, a value stored in the bandwidth-necessary-while-active field 122 of the received bandwidth information management table update packet 12.

When there is no record entry that has the extracted IP address, the bandwidth information receiving unit 25 adds a new record entry to the bandwidth information management table 11. As the computer address 110 of the new record entry, the bandwidth information receiving unit 25 stores the IP address extracted from the bandwidth information management table update packet 12. The bandwidth information receiving unit 25 then stores, as the computer state 111 of the new record entry, a value stored in the computer state field 121 of the received bandwidth information management table update packet 12. A value stored in the bandwidth-necessary-while-active field 122 of the received bandwidth information management table update packet 12 is entered as the bandwidth-necessary-while-active 112 of the new record entry.

Through this processing, the same values as in the bandwidth information management table 24 of the bandwidth management server 5 are stored in the bandwidth information management table 11 of every computer 1.

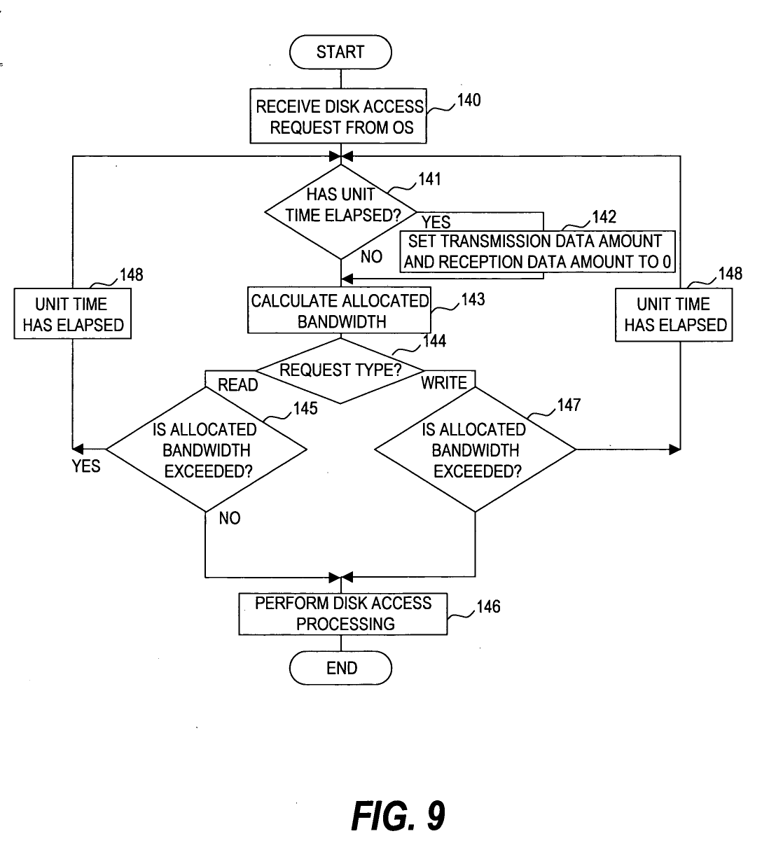

FIG. 9 is a flow chart for processing of the transmission/reception rate control unit 23 in the computer 1 according to the first embodiment.

The OS 14 is instructed by the application 10 to access a disk and issues a disk access request. Then the OS 14 sends the issued disk access request to the iSCSI initiator 21.

A disk access request is a data write request or a data read request. A write request includes a request type, a write data size, and write data. A read request includes a request type and a read data size. A request type is included to indicate whether the access request in question is a write request or a read request.

The transmission/reception rate control unit 23 of the iSCSI initiator 21 receives a disk access request from the OS 14 (140).

The transmission/reception rate control unit 23 then judges whether a unit time set in advance has passed or not (141). Specifically, the transmission/reception rate control unit 23 judges whether a unit time has elapsed or not by judging whether or not the difference between the current time and a reference time is equal to or larger than the unit time. A reference time is a time used to measure a unit time, and is set to a time immediately after the unit time has passed.

Judging that the unit time has not elapsed, the transmission/reception rate control unit 23 proceeds directly to step 143.

In the case where the unit time has elapsed, the transmission/reception rate control unit 23 sets a transmission data-amount and a reception data amount that are being measured to 0 (142). The transmission/reception rate control unit 23 thus measures the amount of data transmitted and received since the start of the unit time. In other words, the transmission/reception rate control unit 23 measures the transmission data amount and reception data amount per unit time. The transmission/reception rate control unit 23 then sets the current time as a reference time.

Next, the transmission/reception rate control unit 23 picks up from the bandwidth information management table 11 a record entry whose computer address 110 matches an IP address assigned to the computer 1 to which the transmission/reception rate control unit 23 belongs. The transmission/reception rate control unit 23 extracts the computer state 111 from the picked up record entry, and judges whether or not the extracted computer state 111 says “manipulated”.

When “manipulated” is written as the computer state 111, the transmission/reception rate control unit 23 extracts the bandwidth-necessary-while-active 112 from the picked up record entry, and sets the extracted bandwidth-necessary-while-active 112 as an allocated bandwidth.

When “not manipulated” is written as the computer state 111, the transmission/reception rate control unit 23 picks up from the bandwidth information management table 11 every record entry that has “manipulated” as the computer state 111. Then the transmission/reception rate control unit 23 calculates a sum A of the bandwidth-necessary-while-active 112 of every picked up record entry. The transmission/reception rate control unit 23 next obtains a bandwidth B of the network 2 which is available to the computer system. The bandwidth B of the network 2 which is available to the computer system is set in advance.

The transmission/reception rate control unit 23 next obtains a count C of record entries in the bandwidth information management table 11 that have “not manipulated” as the computer state 111.

Then the transmission/reception rate control unit 23 obtains an allocated bandwidth through the following expression (1) (143).
Allocated bandwidth=(B−A)/C (1)

The transmission/reception rate control unit 23 may use other methods than the expression (1) in obtaining an allocated bandwidth. For instance, the transmission/reception rate control unit 23 may subtract A from B to distribute the obtained difference according to the ratio of the bandwidth-necessary-while-active 112 of record entries in the bandwidth information management table 11 that have “not manipulated” as the computer state 111.

Once obtaining an allocated bandwidth, the transmission/reception rate control unit 23 judges whether the disk access request received in step 140 is a read request or a write request (144).

In the case where the disk access request is a read request, the transmission/reception rate control unit 23 extracts a transfer size from this disk access request. The transmission/reception rate control unit 23 adds the extracted transfer size to a reception data amount that is being measured. Then the transmission/reception rate control unit 23 judges whether or not the resultant sum is larger than the allocated bandwidth that has been obtained in step 143. The transmission/reception rate control unit 23 thus judges whether or not the allocated bandwidth is exceeded when this disk access request is sent (145). In this way, the transmission/reception rate control unit 23 can judge whether an allocated bandwidth is exceeded or not for each disk access request, which is an iSCSI packet.

In the case where the allocated bandwidth is not exceeded, the transmission/reception rate control unit 23 carries out disk access processing (146). Specifically, the transmission/reception rate control unit 23 sends the disk access request to the storage system 3 by the iSCSI protocol. The transmission/reception rate control unit 23 next receives a response to the transmitted disk access request. The transmission/reception rate control unit 23 sends the received response to the OS 14.

On the other hand, in the case where the allocated bandwidth is exceeded, the transmission/reception rate control unit 23 waits until the unit time elapses (148). Thereafter, the transmission/reception rate control unit 23 returns to step 141.

When it is judged in step 144 that the disk access request is a write request, the transmission/reception rate control unit 23 extracts a transfer size from this disk access request. The transmission/reception rate control unit 23 adds the extracted transfer size to a transmission data amount that is being measured. Then the transmission/reception rate control unit 23 judges whether or not the resultant sum is larger than the allocated bandwidth that has been obtained in step 143. The transmission/reception rate control unit 23 thus judges whether or not the allocated bandwidth is exceeded when this disk access request is sent (147). In this way, the transmission/reception rate control unit 23 can judge whether an allocated bandwidth is exceeded or not for each disk access request, which is an iSCSI packet.

In the case where the allocated bandwidth is not exceeded, the transmission/reception rate control unit 23 carries out disk access processing (146).

On the other hand, in the case where the allocated bandwidth is exceeded, the transmission/reception rate control unit 23 waits until the unit time elapses (148). Thereafter, the transmission/reception rate control unit 23 returns to step 141.

As has been described, the computer system of this embodiment gives priority to the computer 1 that is being used by a user in allocating a bandwidth.

The computer 1 divides an iSCSI packet into a plurality of IP packets before sending or receiving the iSCSI packet. Determining transmission timing for each IP packet that is created by dividing an iSCSI packet leaves a possibility that the computer 1 enters a stand-by state while one iSCSI packet is being transmitted. The storage system 3, which receives an iSCSI packet from the computer 1, therefore has to be equipped with an iSCSI packet reception buffer.

However, the computer 1 of this embodiment controls a bandwidth by determining transmission timing for each iSCSI packet. Accordingly, the storage system 3 of this embodiment does not need to have an iSCSI packet reception buffer.

This embodiment is favorably applied to a disk-less system. A disk-less system includes a computer and a storage system. The computer stores programs such as an OS and an application in the storage system connected to the computer via a network instead of storing them in sub-storage such as a hard disk. In executing a program, the computer reads the program stored in the storage system onto a memory via the network. This enables the computer to operate without incorporating sub-storage such as an HDD (hard disk drive).

In the disk-less system, however, network congestion makes the operation of the computer unstable since the computer accesses the storage system via the network instead of sub-storage to execute a program.

In the computer system of this embodiment, the computer 1 that is being used by a user is preferentially allocated a bandwidth and thus stable operation is ensured for the computer 1 that is being used by a user. Therefore, the computer system of this embodiment is favorably applied to a disk-less system.

(Second Embodiment)

In a second embodiment, the computer 1 has the function of the bandwidth management server 5.

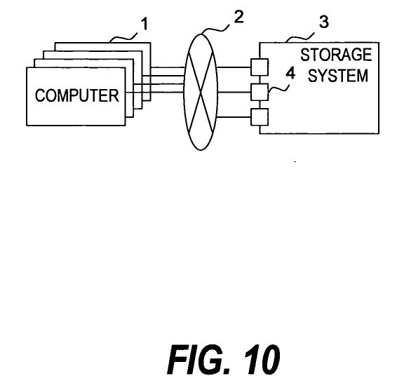

FIG. 10 is a block diagram of a computer system according to the second embodiment.

The computer system of the second embodiment does not include the bandwidth management server 5. The rest of the configuration of the computer system according to the second embodiment is the same as the computer system described in the first embodiment with reference to FIG. 1. Components common to the first embodiment and the second embodiment are denoted by the same reference numerals to avoid repetitive explanation.

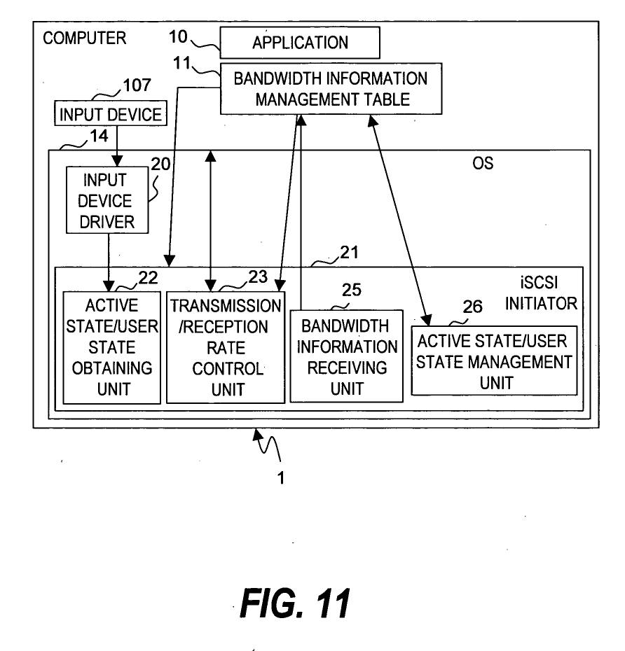

FIG. 11 is a block diagram about functions of the computer 1 according to the second embodiment.

The iSCSI initiator 21 in the OS 14 of the computer 1 according to the second embodiment includes the active state/user state management unit 26. The active state/user state management unit 26 may be provided in every computer 1, or in some of the computers 1. The rest of the configuration of the computer 1 according to the second embodiment is the same as the computer 1 described in the first embodiment with reference to FIG. 3. Components common to the computer 1 of the first embodiment and the computer 1 of the second embodiment are denoted by the same reference numerals to avoid repetitive explanation.

A case in which every computer 1 is equipped with the active state/user state management unit 26 will be described first. In this case, the computer 1 updates its own bandwidth information management table 11 when its active state or manipulation state changes. Then the computer 1 sends the bandwidth information management table update packet 12 shown in FIG. 5 to every other computer 1. Receiving the bandwidth information management table update packet 12, the computer 1 updates its bandwidth information management table 11 in accordance with the bandwidth information management table update packet 12.

Described next is a case in which only one computer 1 is equipped with the active state/user state management unit 26. In this case, the computer 1 that does not have the active state/user state management unit 26 updates its own bandwidth information management table 11 when its active state or manipulation state changes. This computer 1 then sends the bandwidth information management table update packet 12 shown in FIG. 5 to the computer 1 that is equipped with the active state/user state management unit 26.

The computer 1 that is equipped with the active state/user state management unit 26 consults the received bandwidth information management table update packet 12 to update its bandwidth information management table 11. Then the computer 1 that is equipped with the active state/user state management unit 26 transfers the received bandwidth information management table update packet 12 to every other computer 1.

Receiving the bandwidth information management table update packet 12, the computer 1 updates its bandwidth information management table 11 in accordance with the bandwidth information management table update packet 12.

In this way, the computer system of the second embodiment which does not have the bandwidth management server 5 synchronizes the bandwidth information management table 11 of every computer 1.

The rest of the processing of the computer system according to the second embodiment is the same as the processing described in the first embodiment with reference to FIG. 9, and the description will not be repeated here.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, having at least one storage system, a plurality of host computers connected to the storage system via a network, and a management computer connected to the host computers,
the storage system comprising: a first interface connected to the network; a first processor connected to the first interface; a first memory connected to the first processor; and a disk drive for storing data requested by the host computers to be written,
the host computers each comprising: a second interface connected to the network; a second processor connected to the second interface; and a second memory connected to the second processor,
the management computer comprising: a third interface connected to the host computers; a third processor connected to the third interface; and a third memory connected to the third processor,
wherein the second processor monitors a state of the host computer to which the second processor belongs,
wherein the second processor judges whether or not the state is a priority state in which operation of the host computer monitored by the second processor needs to be given priority,
wherein, when the state of the host computer is judged as a priority state, the second processor communicates over a priority bandwidth, and
wherein, when the state of the host computer is judged as not a priority state, the second processor performs communication over a non-priority bandwidth, which corresponds to one of a part and an entirety of a bandwidth remaining after allocating priority bandwidths to other host computers that are in a priority state.

2. The computer system according to claim 1,
wherein the second memory of each of the plurality of host computers stores bandwidth management information, which indicates the state of the host computer and a priority bandwidth of the host computer,
wherein, when the state of the host computer is judged as not a priority state, the second processor
refers to the bandwidth management information
calculates a sum of priority bandwidths to be allocated to other host computers that are in a priority state;
calculates a remaining bandwidth of the network by subtracting the calculated sum of the priority bandwidths from a whole bandwidth of the network; and
calculates a non-priority bandwidth by distributing the calculated remaining bandwidth among the host computers that are not in a priority state, and
communicates over the calculated non-priority bandwidth.

3. The computer system according to claim 2,
wherein the second processor notifies the third processor of the monitored state of the host computer, and
wherein the third processor updates the notified state of the host computer on the bandwidth management information which is stored in the second memory of each of the host computer.

4. The computer system according to claim 1,
wherein the second processor judges that the state of the host computer to which the second processor belongs is a priority state while the host computer is being used by a user, and
wherein the second processor judges that the state of the host computer to which the second processor belongs is not a priority state while the host computer is not being used by a user.

5. The computer system according to claim 1,
the host computers each further comprising an input device,
wherein the second processor monitors the manipulation state of the input device,
wherein the second processor judges that the state of the host computer is a priority state when the input device is being manipulated, and
wherein, the second processor judges that the state of the host computer is not a priority state when the input device is not manipulated.

6. The computer system according to claim 1, wherein the second processor controls a bandwidth by determining iSCSI command transmission timing for each iSCSI command individually.

7. A bandwidth control method for a computer system that has at least one storage system, a plurality of host computers connected to the storage system via a network, and a management computer connected to the host computers, the method comprising the steps of:
monitoring, by the host computer, a state of the host computer;
judging, by the host computer, whether or not the state of the each host computer is a priority state in which operation of the host computer needs to be given priority over other host computers;
communicating, by the host computer, over a priority bandwidth when it is judged that the state of the host computer is a priority state; and
communicating, by the host computer, when it is judged that the state of the host computer is not a priority state, over a non-priority bandwidth, which corresponds to one of a part and an entirety of a bandwidth remaining after allocating priority bandwidths to other host computers that are in a priority state.

8. The bandwidth control method according to claim 7, further comprising the steps of:
storing, by the host computer, bandwidth management information, which indicates the state of each of the plurality of host computers and a priority bandwidth of the host computer;
when the host computer judges that the state of the host computer is not a priority state,
refers to the bandwidth management information
calculating a sum of priority bandwidths to be allocated to other host computers that are in a priority state;
calculating a remaining bandwidth of the network by subtracting the calculated sum of the priority bandwidths from a whole bandwidth of the network; and
calculating a non-priority bandwidth by distributing the calculated remaining bandwidth among the host computers that are not in a priority state; and
communicating over the obtained non-priority bandwidth.

9. The bandwidth control method according to claim 8, further comprising the steps of:
notifying the management computer of the monitored state of the host computer; and
updating, by the management computer, the notified state of the host computer on bandwidth management information which is stored in the each host computer.

10. The bandwidth control method according to claim 7,
wherein the state of the host computer is judged a priority state while the host computer is being used by a user, and
wherein the state of the host computer is not judged a priority state while the host computer is not being used by a user.

11. The bandwidth control method according to claim 7,
wherein the host computers each further comprise an input device,
wherein the state of the host computer is judged a priority state when the input device is being manipulated, and
wherein, the state of the host computer is not judged a priority state when the input device is not manipulated.

12. The bandwidth control method according to claim 7, wherein the host computer controls bandwidth by determining iSCSI command transmission timing for each iSCSI command individually.

13. A program executed by a plurality of host computers that are connected to a storage system via a network, comprising the processings of:
monitoring a state of the host computer that executes the program;
judging whether or not the monitored state of the host computer is a priority state in which operation of the monitored host computer needs to be given priority over other host computers;
communicating over a priority bandwidth when it is judged that the monitored state of the host computer is a priority state; and
communicating, when it is judged that the monitored state of the host computer is not a priority state, over a non-priority bandwidth, which corresponds to one of a part and an entirety of a bandwidth remaining after allocating priority bandwidths to other host computers that are in a priority state.

14. The program according to claim 13, further comprises the processing of storing bandwidth management information, which indicates the state of each of the plurality of host computers and a priority bandwidth of the host computer,
wherein, in the processing of communicating over a non-priority bandwidth, when the state of the host computer is not a priority state, the host computer
refers to the bandwidth management information
calculates a sum of priority bandwidths to be allocated to other host computers that are in a priority state;
calculates a remaining bandwidth of the network by subtracting the calculated sum of the priority bandwidths from a whole bandwidth of the network; and
calculates a non-priority bandwidth by distributing the calculated remaining bandwidth among the host computers that are not in a priority state, and
wherein communicates over the obtained non-priority bandwidth.

15. The program according to claim 14, further comprising a processing of updating the state of the monitored host computer on bandwidth management information of which is stored in the each host computer.

16. The program according to claim 13, wherein, in the processing of judging whether or not the host computer that executes the program is in a priority state, it is judged that the state of the host computer that executes the program is a priority state while this host computer is being used by a user, and it is judged that the state of the host computer that executes the program is not in a priority state while this host computer is not being used by a user.

17. The program according to claim 13,
wherein the host computers each further comprise an input device, and
wherein, in the processing of judging whether or not the state of the host computer that is being monitored is a priority state, the host computer judges that the state of the host computer is a priority state when the input device is manipulated and, the host computer dose not judge that the state of the host computer is a priority state when the input device is not manipulated.

18. The program according to claim 13, wherein, in the processing of communicating over a priority bandwidth and in the processing of communicating over a non-priority bandwidth, controlling bandwidth by determining iSCSI command transmission timing for each iSCSI command individually.
